(19) United States
(12) Patent Application Publication
(10) Pub. No.: US 2004/0111934 A1
(43) Pub. Date: Jun. 17, 2004

(54) Packaging system for and method of marketing and labeling alcoholic consumables

(76) Inventor: Mark O'Connell, Kansas City, MO (US)

Correspondence Address: HOVEY WILLIAMS LLP, 2405 GRAND BLVD., SUITE 400, KANSAS CITY, MO, 64108, US

(21) Appl. No.: 10/322,286

(22) Filed: Dec. 17, 2002

(51) Int. Cl. G09F 3/00

(52) U.S. Cl. 40/310; 40/638

(57) ABSTRACT

A packaging system for and method of marketing and labeling alcoholic consumables, such as, for example, wine or liquor, subject to federal, state, or other jurisdictional regulation. Broadly, a service provider ascertains and monitors the diverse and varied regulations of a broad multi-jurisdictional market and ensures compliance therewith, and generates standardized labels that, with a distinctive brand and in a consistent manner, communicate both regulation-required and consumer-desired information regarding the alcoholic consumables produced by a variety of independent producers. The labels may be provided in duplicate, with easily removable first instances applied over permanently affixed second instances so as to facilitate providing consumers with copies of the labels.

### BACKGROUND OF THE INVENTION

1. Field of the Invention

The present invention relates broadly to systems and methods for packaging, including marketing and labeling, regulated consumables. More particularly, the present invention concerns a packaging system and method of marketing and labeling alcoholic consumables crafted by multiple independent producers, wherein a service provider ascertains and monitors the diverse and varied jurisdictional regulations and ensures compliance therewith, and wherein the service provider generates standardized packaging that, with a distinctive brand and in a consistent manner, communicates both regulation-required and consumer-desired information regarding each independent producer's alcoholic consumables, and wherein the quality and character of each independent producer's alcoholic consumables remains discrete from other independent producers' alcoholic consumables packaged by the service provider under the distinctive brand.

2. Description of the Prior Art

It will be appreciated by those with ordinary skill in the art of packaging and marketing alcoholic consumables, such as, for example, wine and liquor, that such activities are subject to widely varying regulations. In the United States, for example, each state may establish its own diverse regulations, and within each state or other jurisdictions may establish their own diverse regulations. These regulations often address or include requirements for such activities as reporting, advertising, selling, and labeling.

Smaller-scale vineyards, distillers, brewers, and other producers are generally known to provide a greater variety and uniqueness of alcoholic consumables. Unfortunately, smaller-scale producers, particularly those in foreign countries, often find it too difficult or expensive to ascertain and monitor the regulations of each jurisdiction in order to comply therewith. By limiting marketing and sales to their own locale and perhaps a very limited number of other jurisdictions, the smaller-scale producers are able to minimize costs associated with regulatory compliance. Unfortunately, from both the producers' and the public's perspectives, this solution undesirably limits the market exposure and availability of the affected alcoholic consumables.

Similarly, smaller-scale producers produce smaller volumes and therefore do not enjoy economies of scale with regard to labor or supplies such as, for example, boxes, bottles, labels, and corks or other packaging materials. These costs are passed on to consumers, so that smaller-scale producers are also generally known for higher-cost alcoholic consumables.

Further detracting from any multi-jurisdictional marketing and sales decision is that the relatively small product volumes associated with smaller-scale producers can often make building a brand-name presence in a broad market very difficult, if not completely impractical. The cost to develop a positive, broadly recognized brand is independent of the size of a producer's production.

On the other hand, larger-scale vineyards, distillers, brewers, and other producers are generally known to provide less variety and uniqueness of alcoholic consumables. Due to larger product volumes and economies of scale, however, the costs passed on to consumers can be substantially lower. Larger scale producers are also better able to afford the costs of ascertaining, monitoring, and complying with the regulations of a large number of jurisdictions. Their ability to do so, however, makes the associated effort and expense no more desirable.

Furthermore, it will be appreciated by consumers that the labeling of alcoholic consumables often seems to have little or no consistency and often fails to provide certain desirable information about the producer or the alcoholic consumable itself. It may, for example, be desirable to the consumer to have access to such information as a history or other background of the producer and a description of the aromatics and flavors of and food pairing recommendations for the alcoholic consumable.

Additionally, it will be appreciated by marketers and sellers that consumers can be reluctant to try new or different alcoholic consumables due to an inherent inability to sample prior to purchase. Under certain circumstances, a sommelier or sales person is present and able to provide a recommendation, but under other circumstances, no such recommendation or other assurance of quality is available.

Additionally, it will be appreciated by wait staff that consumers who have sampled and enjoyed a particular alcoholic consumable often ask to have and keep for future reference the conventional single label affixed to the bottle or other package. This typically requires that the single label be laboriously soaked with water to facilitate such removal and avoid ripping or otherwise rendering it unreadable, oftentimes to no avail.

Due to the above-identified and other problems and disadvantages in the art, a need exists for an improved method of marketing and labeling alcoholic consumables.

### SUMMARY OF THE INVENTION

The present invention overcomes the above-identified and other problems and disadvantages in the prior art by providing a packaging system and method of efficiently and cost-effectively marketing and labeling alcoholic consumables, such as, for example, wine or liquor, subject to federal, state, or other jurisdictional regulation. The packaging system and method provides the advantages of both smaller-scale and larger-scale producers, while substantially reducing or eliminating the disadvantages. Broadly, a service provider ascertains and monitors the diverse and varied regulations of a broad multi-jurisdictional market and ensures compliance therewith, and generates standardized packaging that, with a distinctive brand and in a consistent manner, communicates both regulation-required and consumer-desired information regarding the alcoholic consumables.

In a preferred embodiment, the packaging system includes a distinctive front label and an informative back label. The front label distinctively identifies the brand that the service provider creates such that consumers seeing the front label come to expect certain features, including the informative back label, and a consistent high quality of the associated alcoholic consumables. The front label broadly includes a brand identification portion and a product identification portion. The brand identification portion includes a name, logo, symbol or other mark or any combination thereof that is unique and distinctive. Additionally, the front label may be provided with a distinctive color, color scheme, font, shape, or other design element that the consumer can associate with the brand. Thus, the name, logo, or other symbol or mark of the brand will eventually become associated with both the advantageous features disclosed herein and consistently high product quality, without regard to any specific producer or alcoholic consumable. Furthermore, such association and recognition may advantageously spur consumers to try various alcoholic consumables on the strength of the brand's reputation alone. The product identification portion includes a name that distinctively identifies the particular alcoholic consumable. Alternative or additional portions may be included as required by regulation by any of the jurisdictions within the broad market.

The back label distinctively conveys regulation-required or consumer-desired information about the service provider, the producer, and the alcoholic consumable. Consumers seeing the distinctive front label will come to expect and rely on the informative back label to provide the aforementioned convenient information to assist in evaluating and selecting the alcoholic consumable. The back label broadly includes a brand information portion; a producer information portion; and a product specific information portion. The brand information portion includes relevant information concerning the brand, such as, for example, a mission statement and a mailing address, a website address, or other contact information. The producer information portion includes relevant information about the producer of the alcoholic consumable, such as, for example, a brief history or other background. The product specific information portion includes consistent, relevant information about the alcoholic consumable, such as an overview of the production methods, a brief description of the aromatics and flavors, a recommendation of food pairings, and any aging potential. As appropriate and subject to regulation, alternative or additional information, identification, or disclosures may be included in any of the aforementioned portions in order to more clearly or distinctively convey the regulation-required or consumer-desired information.

As mentioned, the general look and feel of the front and back labels are substantially consistent, regardless of any particular producer of an alcoholic consumable, so that the consumer comes to identify the associated alcoholic consumables as being carefully selected, endorsed, and recommended by the brand of the service provider and therefore providing certain consistent features and quality. This consistency of content and presentation advantageously allows consumers to quickly and efficiently evaluate and make their selections from alcoholic consumables from a variety of independent producers.

Furthermore, at least the front label, and perhaps the back label as well, is preferably provided in duplicate, with first instances of the front and back labels being securely and permanently affixed, such as, for example, by a permanent adhesive, to the bottle or other packaging, and second instances of the front and back labels being removably applied, such as, for example, by a non-permanent adhesive, over the respective first instances. This advantageous feature allows for more easily and conveniently providing the consumer with copies (the second instances) of the labels for future reference.

The method of marketing and labeling the alcoholic consumables proceeds as follows. After an evaluation process, the service provider contracts with the independent producers to market the alcoholic consumables. The service provider and each producer together develop the relevant content for the informative back label. Concurrently, the service provider ascertains all applicable regulations for every jurisdiction within which the alcoholic consumables will be marketed and sold. Also concurrently, the service provider either develops a unique brand to be associated with the independent producers, or selects one of its existing brands to associate with the producers. Next, the service provider collects the content unique to each producer to appear on the front and back labels, and designs the front and back labels to incorporate the unique content and to comply with the applicable regulations. Next, the front and back labels are created and submitted to various regulatory agencies for approval. Upon such approval, the packaging is created, including front and back labels, capsules, corks, bottles, and boxes and delivered to the producers for bottling and packaging. The packaged and labeled alcoholic consumables are then delivered to wholesalers, retailers, restaurants, and other sellers and outlets in the broad market, and the service provider, in accordance with the ascertained applicable regulations, engages in marketing and advertising the brand. Thereafter, periodically or continuously, the service provider monitors the jurisdictions for any changes to the applicable regulations that might affect current or future marketing or labeling efforts by, for example, requiring additional or alternate content, including pricing and promotions.

Thus, it will be appreciated that the system and method of the present invention provide a number of substantial advantages over the prior art, including, for example, advantageously reducing the costs of ascertaining, monitoring, and reporting related to the diverse and varied regulations of a broad multi-jurisdictional market, compared with each independent producer acting on their own. As a result, producers, particularly smaller-scale producers, enjoy greater exposure and consumers enjoy greater variety and availability of the alcoholic consumables at lower cost. Thus, the present invention provides the benefits and advantages of both smaller-scale and larger-scale producers, while substantially reducing or eliminating the disadvantages.

Furthermore, the present invention advantageously provides standardized labels for the alcoholic consumables that, in a consistent manner, communicate both regulation-required and consumer-desired information regarding the alcoholic consumables. Thus, interested consumers can become more aware and informed of the alcoholic consumables. Also, such consistency of content and presentation advantageously allows consumers to quickly and efficiently evaluate and make their selections from a variety of alcoholic consumables.

Additionally, consumers may be more willing to try new or different alcoholic consumables as the distinctive labels come to be associated with high product quality implicit in the brand. Also, the aforementioned label content and substantial consistency thereof can provide additional information and assurances to assuage the consumers' trepidation.

Additionally, the aggregation of the individual producer's alcoholic consumables under a single brand allows the service provider to leverage advertising expenses by combining such expenses under a single brand representing multiple producers. In the prior art, the service provider, by definition, was required to advertise each independent producer individually and no one producer received any benefit of being associated with any other producer marketed by the same service provider.

Additionally, the present invention advantageously provides for an easily removable and substantially identical second or outer label that can be given to consumers for their future reference and convenience in selecting alcoholic consumables, thereby eliminating the laborious soaking and peeling required to remove conventional single labels.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a plan view of a distinctive front label of a preferred embodiment of the present invention;

FIG. 2 is a first example of the distinctive front label of FIG. 1 adapted for a particular alcoholic consumable produced by a first producer;

FIG. 3 is a second example of the distinctive front label of FIG. 1 adapted for a particular alcoholic consumable produced by a second producer;

FIG. 4 is a plan view of an informative back label of the preferred embodiment of the present invention;

FIG. 5 is a first example of the informative back label of FIG. 3 adapted for the particular alcoholic consumable and the first producer of FIG. 2;

FIG. 6 is a second example of the informative back label of FIG. 3 adapted for the particular alcoholic consumable and the second producer of FIG. 3;

FIG. 7 is an isometric view of first and second instances of the distinctive front and informative back labels of FIGS. 1 and 4, shown in use on a bottle;

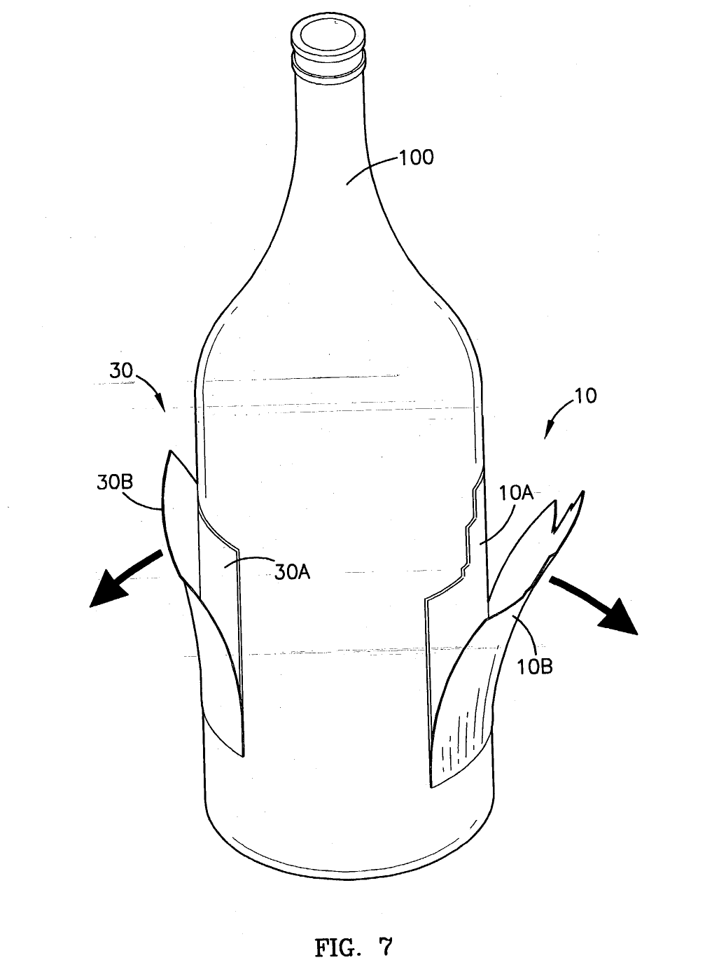

FIG. 8 is a first part of a flowchart of steps involved in practicing the preferred embodiment of the present invention; and

FIG. 9 is a second part of the flowchart of FIG. 8.

### DETAILED DESCRIPTION OF A PREFERRED EMBODIMENT

Referring to the figures, a packaging system and method of marketing and labeling alcoholic consumables is disclosed in accordance with a preferred embodiment of the present invention. More particularly, the present invention concerns a packaging system for and method of efficiently and cost-effectively marketing and labeling alcoholic consumables, such as, for example, wine or liquor, subject to federal, state, or other jurisdictional regulation. The packaging system and method provide the advantages of both smaller-scale and larger-scale producers, while substantially reducing or eliminating the disadvantages. Broadly, a service provider ascertains and monitors the diverse and varied regulations of a broad multi-jurisdictional market and ensures compliance therewith, and generates standardized packaging that with a brand and in a consistent manner distinctively communicates both regulation-required and consumer-desired information regarding the alcoholic consumables.

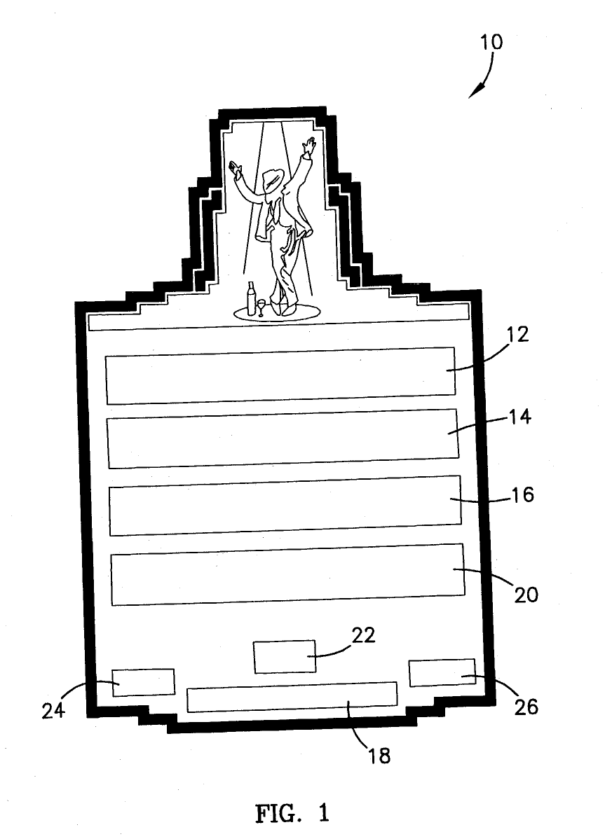

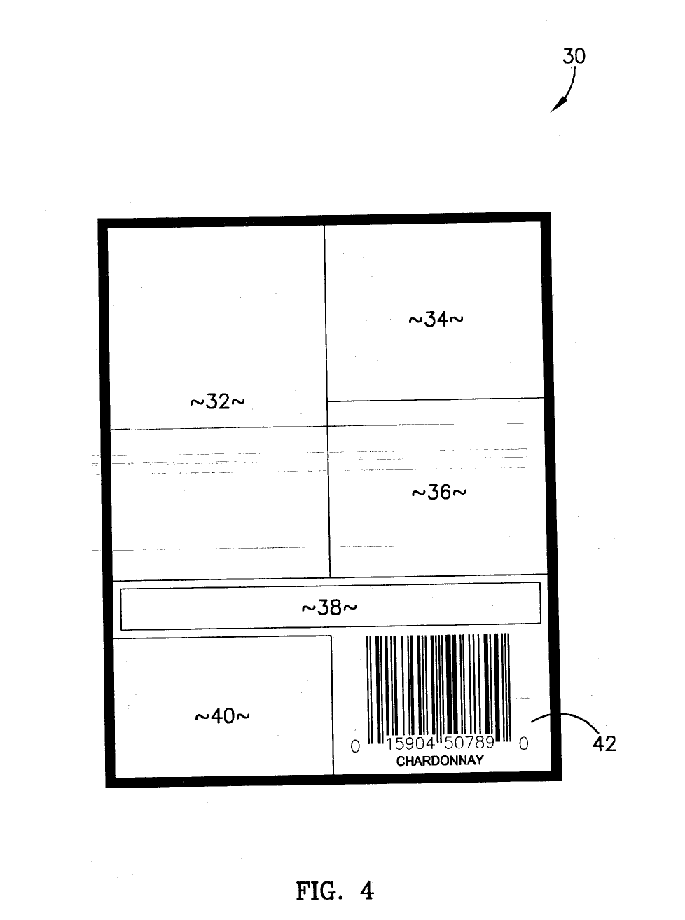

In a preferred embodiment, the packaging system broadly comprises a distinctive front label 10 (see FIG. 1) and an informative back label 30 (see FIG. 4). The front label 10 distinctively identifies the brand such that consumers seeing the front label 10 will come to expect certain advantageous features, including the informative back label 30, and a consistent quality of the associated alcoholic consumables. The front label 10 broadly includes a brand identification portion 12; a product identification portion 14; a region identification portion 16; a country identification portion 18; a locale identification portion 20; a year portion 22; a content volume portion 24; and an alcohol content portion 26. Alternative or additional portions may be included as required by regulation by any of the jurisdictions within the broad market.

The brand identification portion 12 includes a name, logo, symbol or other mark or any combination thereof that distinctively identifies the brand. Alternatively or additionally, the front label 10 may be provided with a distinctive color, color scheme, font, shape, or other design element that the consumer can associate with the service provider. Thus, the brand of the service provider will eventually become associated with both the advantageous features disclosed herein and consistently high product quality, without regard to any specific producer or alcoholic consumable. Furthermore, such association and recognition may advantageously spur consumers to try new or different alcoholic consumables on the strength of the brand's reputation alone.

The product identification portion 14 includes a name that distinctively identifies the particular alcoholic consumable. The region identification portion 16 includes an actual or popular name of a geographic region (e.g., of an interior area or range or coastal area) associated with either the producer or the ingredients of the alcoholic consumable. The country identification portion 18 and the locale identification portion 20 include, respectively, a name of a country and a name of a lesser political jurisdiction (e.g., province, state, or county) associated with either the producer or the ingredients of the alcoholic consumable. The year portion 22 indicates a year or other time period in which the alcoholic consumable was bottled, packaged, or otherwise prepared. The content volume portion 24 and the alcohol content portion 26 indicate, respectively, a total volume and an alcohol volume (as a percentage of the total volume) of the alcoholic consumable. Subject to regulation, alternative or additional names, logos, symbols or other marks or any combinations thereof, distinctive colors, color schemes, fonts, shapes, or other design elements may be included in any of the aforementioned portions in order to more clearly or distinctively convey the required or desired information.

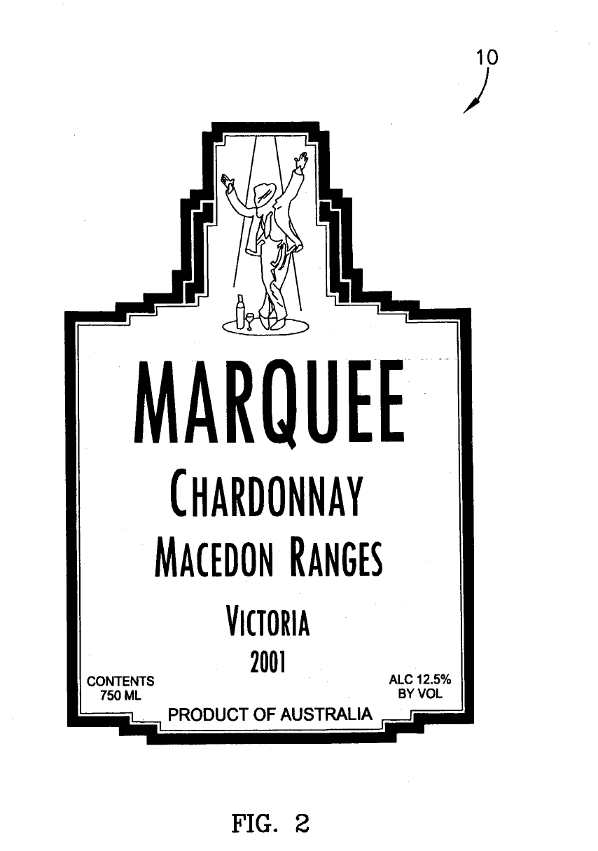

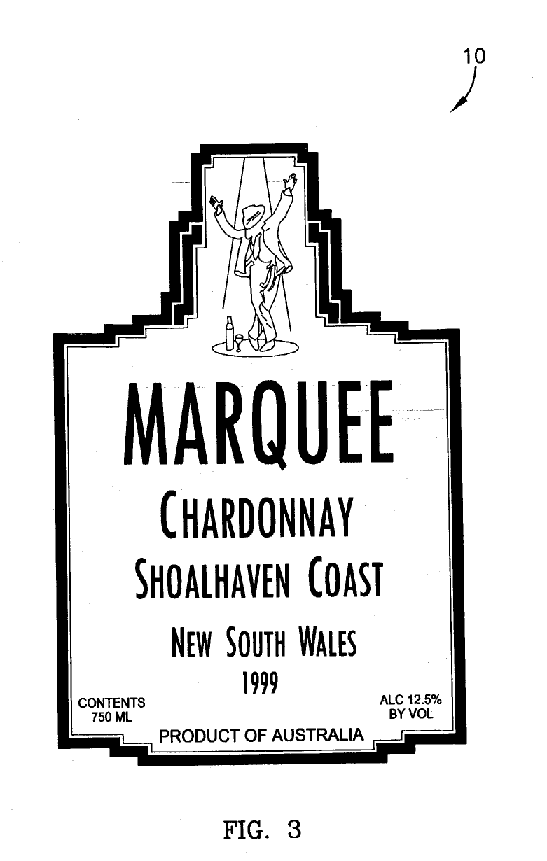

A first example of the distinctive front label 10 is shown in FIG. 2 adapted for a particular alcoholic consumable produced by a first producer. A second example of the distinctive front label 10 is shown in FIG. 3 adapted for a particular alcoholic consumable produced by a second producer.

The back label 30 distinctively conveys regulation-required and consumer-desired information about the brand, the producer, and the alcoholic consumable. Consumers seeing the distinctive front label 10 will come to expect and rely on the informative back label 30 to provide the aforementioned convenient information to assist in evaluating and selecting the alcoholic consumable. The back label 30 broadly includes a brand information portion 32; a producer information portion 34; a product specific information portion 36; an import portion 38; a disclosure portion 40; and a UPC portion 42. Alternative or additional portions may be included as required by regulation by any of the jurisdictions within the broad market.

The brand information portion 32 includes relevant information concerning the brand, such as, for example, a mission statement and a mailing address, a website address, or other contact information. The producer information portion 34 includes relevant information about the producer of the alcoholic consumable, such as, for example, a brief history or other background, and may include an appropriate picture or other graphic element. The product specific information portion 36 includes relevant information about the alcoholic consumable, such as an overview of the production methods, a brief description of the aromatics and flavors, a recommendation of food pairings, and any aging potential. The import portion 38 identifies the importer and the distributor. The disclosure portion 40 includes any standard warnings, ingredient-specific warnings, and other required or advisable medical or legal disclosures. The UPC portion includes a conventional UPC code or symbol. As appropriate and subject to regulation, alternative or additional information, identification, or disclosures may be included in any of the aforementioned portions in order to more clearly or distinctively convey the regulation-required or consumer-desired information.

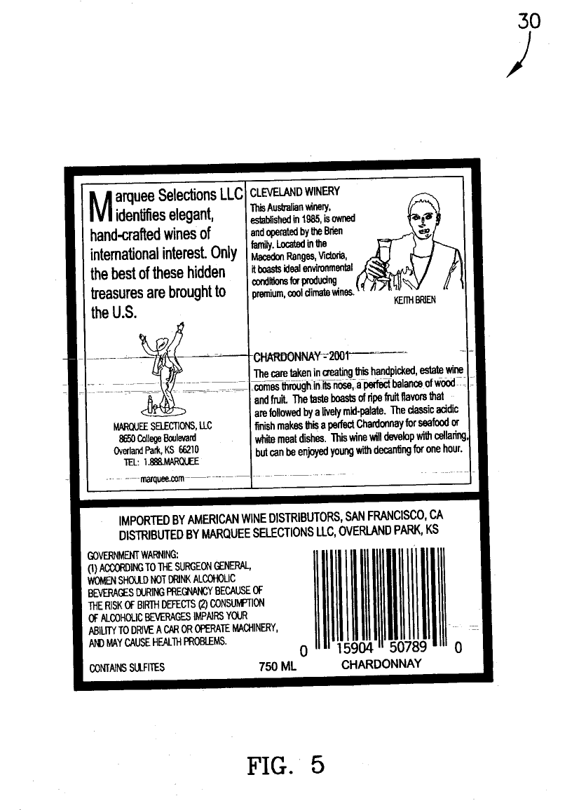

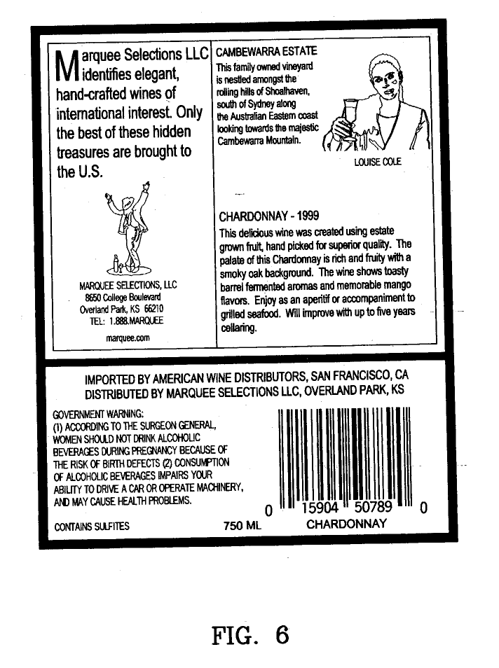

A first example of the informative back label 30 is shown in FIG. 5 adapted for the particular alcoholic consumable produced by the first producer of FIG. 2. A second example of the informative back label 30 is shown in FIG. 6 adapted for the particular consumable produced by the second producer of FIG. 3.

As mentioned, the general look and feel of the front label 10, and the back label 30 is substantially consistent, regardless of any particular producer or alcoholic consumable, so that the consumer comes to identify the associated alcoholic consumables as being endorsed and recommended by the brand and therefore providing certain consistent features and quality. This consistency of content and presentation advantageously allows consumers to quickly and efficiently evaluate and make their selections from a variety of alcoholic consumables and producers.

It will be appreciated that consumers who have sampled and enjoyed a particular alcoholic consumable often ask to have and keep for future reference the conventional single label permanently affixed to the bottle or other package. This typically requires that the single label be laboriously soaked with water to facilitate such removal and avoid ripping or otherwise rendering it unreadable. Referring also to FIG. 5, in the label system of the present invention at least the front label 10, and perhaps the back label 30 as well, is preferably provided in duplicate, with first instances 10A,30A of the front and back labels 10,30 being securely and permanently affixed, such as, for example, by a permanent adhesive, to the bottle 100 or other packaging, and second instances 10B,30B of the front and back labels 10,30 being removably applied, such as, for example, by a non-permanent adhesive, over the respective first instances 10A,30A. The purpose of this advantageous feature is to allow for more easily and conveniently providing the consumer with copies (the second instances) of the labels 10B,30B for future reference.

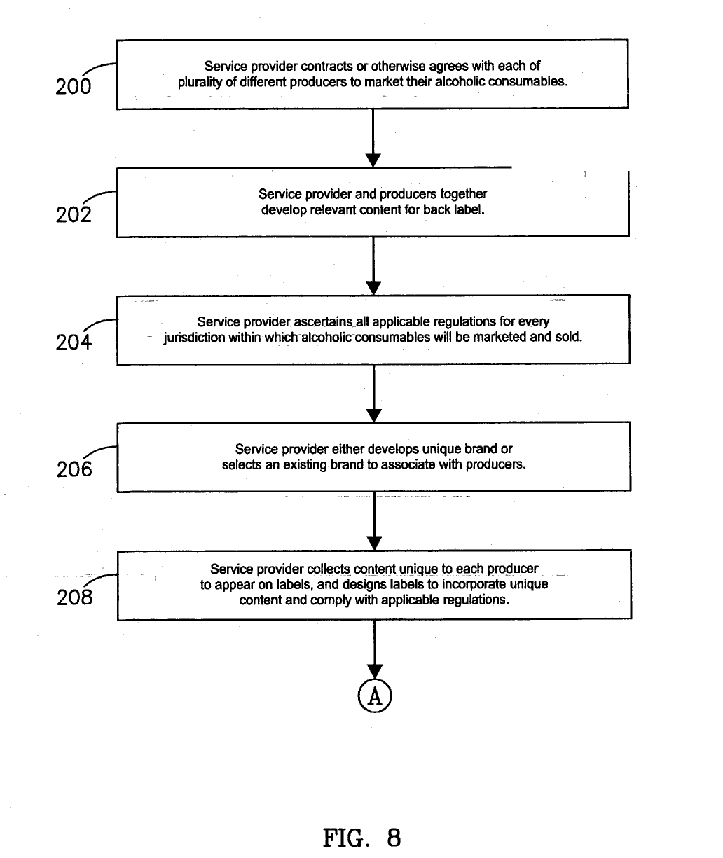

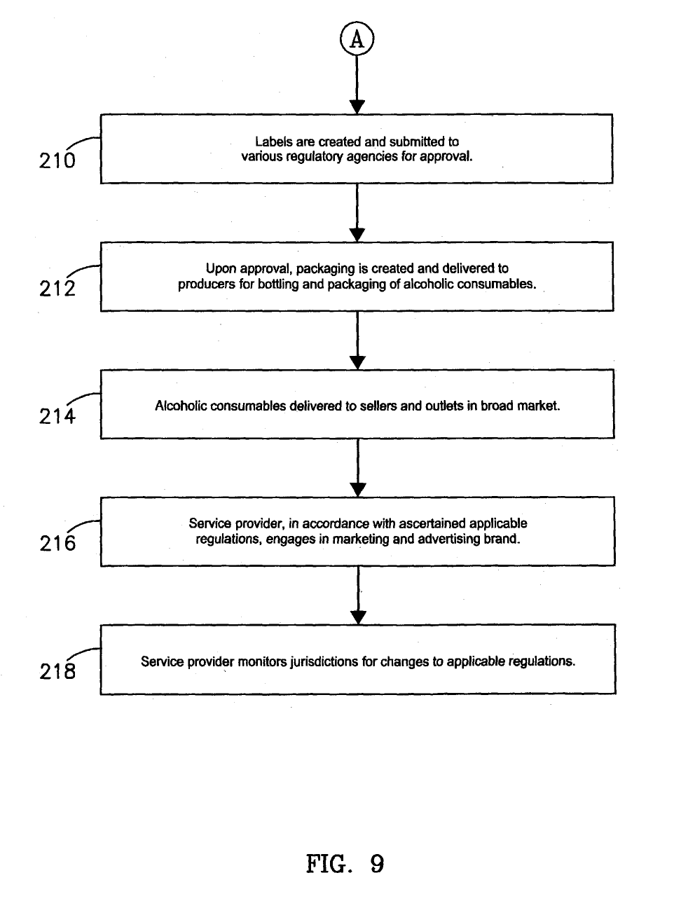

The method of marketing and labeling the alcoholic consumables proceeds as follows. Referring to FIGS. 8 and 9, the service provider contracts with or otherwise agrees with each of a plurality of different independent producers, whether smaller-scale or larger-scale vineyards, distillers, brewers, or other producers, to market their alcoholic consumables, as depicted in box 200. The service provider works with each producer to develop the relevant content for the informative back label 30, as depicted in box 202. Concurrently, the service provider ascertains all applicable regulations for every state, county, city, or other jurisdiction within which the alcoholic consumables will be marketed and sold, as depicted in box 204. Also concurrently, the service provider either develops a unique brand to be associated with the producers, or selects one of its existing brands to associate with the producers, as depicted in box 206.

Next, the service provider collects the content unique to each producer to appear on the front and back labels 10,30, and designs the front and back labels 10,30 to incorporate the unique content and to comply with the applicable regulations, as depicted in box 208. Then, the front and back labels 10,30 are created and submitted to the various regulatory agencies for approval, as depicted in box 210. Because the front and back labels 10,30 are created under a single brand and with substantial consistency, the front and back labels 10,30 for the various alcoholic consumables and producers can be submitted at once because they are part of a template. This has the tendency of advantageously speeding the approval process, and, because subsequent approvals are not required in subsequent years so long as certain portions of the front and back labels 10,30 do not change, compliance costs are reduced. This feature of the present invention provides substantial advantages over the prior art wherein individual producers might make label changes and then, particularly if they are foreign producers, force their importers to resubmit the labels for approval. Upon approval, the packaging is created by the service provider, including front and back labels 10,30, capsules, corks, bottles, and boxes and delivered to the producers for bottling and packaging, as depicted in box 212.

The packaged and labeled alcoholic consumables are then delivered to wholesalers, retailers, restaurants, and other sellers and outlets in the broad market, as depicted in box 214. The service provider then, in accordance with the ascertained applicable regulations, engages in marketing and advertising the brand, as depicted in box 216. The brand eventually becomes associated with both the advantageous features disclosed herein and consistently high product quality, without regard to any particular producer or alcoholic consumable. As mentioned, it will be appreciated that such association and recognition may spur consumers to try various alcoholic consumables on the strength of the brand's reputation alone.

Thereafter, periodically or continuously, the service provider monitors the jurisdictions for any changes to the applicable regulations that might affect current or future marketing or labeling efforts by, for example, requiring additional or alternate content, including pricing and promotions, as depicted in box 218.

It will be appreciated that, although described herein as being adapted for use with alcoholic consumables, the present invention is adaptable for use with substantially any artisanal food product to provide substantially the same benefits.

From the preceding description it will be appreciated that the system and method of the present invention provide a number of substantial advantages over the prior art, including, for example, advantageously substantially reducing the costs of ascertaining, monitoring, and reporting related to the diverse and varied regulations of a broad multi-jurisdictional market, compared with each producer acting on their own. As a result, producers, particularly smaller-scale producers, enjoy greater exposure and consumers enjoy greater variety and availability of the alcoholic consumables at lower cost. Thus, the present invention provides the benefits and advantages of both smaller-scale and larger-scale producers, while substantially reducing or eliminating the disadvantages.

Furthermore, the present invention advantageously provides standardized labels for the alcoholic consumables that, in a consistent manner, communicate both regulation-required and consumer-desired information regarding the alcoholic consumables. Thus, interested consumers can become more aware and informed of the alcoholic consumables. Also, such consistency of content and presentation advantageously allows consumers to quickly and efficiently evaluate and make their selections from a variety of alcoholic consumables.

Additionally, consumers may be more willing to try new or different alcoholic consumables as the distinctive labels come to be associated with high product quality implicit in the brand. Also, the aforementioned label content and substantial consistency thereof can provide additional information and assurances to assuage the consumers' trepidation.

Additionally, the aggregation of the individual producer's alcoholic consumables under a single brand allows the service provider to leverage advertising expenses by combining such expenses under a single brand representing multiple producers. In the prior art, the service provider, by definition, was required to advertise each independent producer individually and no one producer received any benefit of being associated with any other producer marketed by the same service provider.

Additionally, the present invention advantageously provides for an easily removable and substantially identical second or outer label that can be given to consumers for their future reference and convenience in selecting alcoholic consumables, thereby eliminating the laborious soaking and peeling required to remove conventional single labels.

Although the invention has been described with reference to the preferred embodiments illustrated in the drawings, it is noted that equivalents may be employed and substitutions made herein without departing from the scope of the invention as recited in the claims. Thus, for example, it will be appreciated that the front and back labels 10,30 may include additional or alternative identifications, disclosures, information, or other content so as to comply with the applicable regulations of the jurisdictions of the broad market.

Having thus described the preferred embodiment of the invention, what is claimed as new and desired to be protected by Letters Patent includes the following:

1. A packaging system for packaging a plurality of different alcoholic consumables, wherein the packaging system is implemented by a service provider and the plurality of different alcoholic consumables are produced by a plurality of different independent producers, the packaging system comprising:
a distinctive front label adapted to distinctively identify a brand, wherein the brand and a general appearance of the distinctive front label is substantially consistent for all of the plurality of different alcoholic consumables, the distinctive front label including—
a product identification portion adapted to distinctively identify a particular alcoholic consumable of the plurality of different alcoholic consumables; and
an informative back label adapted to provide information concerning the particular alcoholic consumable and a particular independent producer thereof, wherein a general appearance of the informative back label is substantially consistent for all of the plurality of different alcoholic consumables, the informative back label including—
a brand information portion providing information concerning the brand,
a producer information portion providing information concerning the particular independent producer, and
a product specific information portion providing information concerning the particular alcoholic consumable.

2. The packaging system as set forth in claim 1, wherein the distinctive front label and the informative back label are substantially compliant with all applicable regulations of a plurality of jurisdictions.

3. The packaging system as set forth in claim 1, wherein the distinctive front label is provided in duplicate, with a first instance of the distinctive front label being permanently affixable to a package, and a substantially identical second instance of the distinctive front label being removably applied over the first instance of the distinctive front label.

4. The packaging system as set forth in claim 3, wherein the informative back label is provided in duplicate, with a first instance of the informative back label being permanently affixable to the package, and a substantially identical second instance of the informative back label being removably applied over the first instance of the distinctive front label.

5. The packaging system as set forth in claim 1, wherein the producer information portion includes a brief back background of the particular independent producer.

6. The label system as set forth in claim 1, wherein the product specific information portion includes a brief description of the particular alcoholic consumable.

7. A packaging system for packaging a plurality of alcoholic consumables, wherein the packaging system is implemented by a service provider and the plurality of different alcoholic consumables are produced by a plurality of different independent producers, the packaging system comprising:
a first instance of a distinctive front label adapted to distinctively identify a brand and a particular alcoholic consumable of the plurality of different alcoholic consumables, wherein the brand and a general appearance of the distinctive front label is substantially consistent for all of the plurality of alcoholic consumables, with the first instance of the distinctive front label being permanently affixable to a package;
a second instance of the distinctive front label which is substantially identical to the first instance of the distinctive front label, with the second instance of the distinctive front label being removably applied over the first instance of the distinctive front label;
a first instance of an informative back label adapted to provide information concerning a particular independent producer of the particular alcoholic consumable, wherein a general appearance of the informative back label is substantially consistent for all of the plurality of different alcoholic consumables, with the second instance of the informative back label being permanently affixable to the package; and
a second instance of the informative back label which is substantially identical to the first instance of the informative back label, with the second instance of the informative back label being removably applied over the first instance of the informative back label.

8. The packaging system as set forth in claim 7, wherein the distinctive front label and the informative back label are substantially compliant with all applicable regulations of a plurality of jurisdictions.

9. The packaging system as set forth in claim 7, wherein the first instance of the informative back label includes—
a brand information portion providing information concerning the brand;
a producer information portion providing information concerning the particular independent producer; and
a product specific information portion providing information concerning the particular alcoholic consumable.

10. The packaging system as set forth in claim 7, wherein the producer information portion presents a brief background of the particular independent producer.

11. The packaging system as set forth in claim 7, wherein the product specific information portion presents a brief description of the particular alcoholic consumable.

12. A method of marketing and labeling alcoholic consumables, the method comprising the steps of:
(a) agreeing to market a plurality of alcoholic consumables produced by a plurality of different independent producers;
(b) ascertaining, for each of the alcoholic consumables, all applicable regulations for a plurality of jurisdictions within which the particular alcoholic consumable will be marketed and sold;
(c) identifying a brand under which the plurality of alcoholic consumables will be sold;
(d) developing a content to appear on a front label and a back label for the particular alcoholic consumable;
(e) designing the front label and the back label to incorporate the brand and the content and to comply with the applicable regulations;
(f) creating a marketing strategy for the brand that complies with the applicable regulations, and marketing the brand in some or all of the plurality of jurisdictions; and
(g) monitoring the applicable regulations for any changes that affect one or more of the front label, the back label, and the marketing strategy.

13. The method as set forth in claim 12, wherein the plurality of different consumables includes different types of wine.

14. The method as set forth in claim 12, further including the step of providing, for each of the alcoholic consumables, the front label, the back label, and additional packaging materials to the plurality of different independent producers.

15. A method of marketing and labeling alcoholic consumables, the method comprising the steps of:
(a) agreeing to provide labels for a plurality of alcoholic consumables produced by a plurality of different independent producers;
(b) ascertaining, for each of the alcoholic consumables, all applicable regulations for a plurality of jurisdictions within which the alcoholic consumable will be marketed and sold;
(c) identifying a brand under which the plurality of alcoholic consumables will be sold;
(d) developing a content to appear on a front label and a back label for the particular alcoholic consumable;
(e) designing the front label and the back label to incorporate the brand and the content and to comply with the applicable regulations;
(f) providing, for each of the alcoholic consumables, the front label, the back label, and additional packaging materials to the plurality of different independent producers;
(g) creating a marketing strategy for the brand that complies with the applicable regulations;
(h) marketing the brand in some or all of the plurality of jurisdictions; and
(i) monitoring the applicable regulations for any changes that affect one or more of the front label, the back label, and the marketing strategy.

16. The method as set forth in claim 15, wherein the plurality of alcoholic consumables includes different types of wine.
